(19) United States
(12) Patent Application Publication
(10) Pub. No.: US 2011/0185795 A1
(43) Pub. Date: Aug. 4, 2011

(54) TEST APPARATUS

(76) Inventor: Ross Colquhoun, Aberdeen (GB)

(21) Appl. No.: 13/000,214

(22) PCT Filed: Jun. 22, 2009
(86) PCT No.: PCT/GB2009/050712

§ 371 Date: Mar. 24, 2011

(30) Foreign Application Priority Data
Jun. 20, 2008 (GB) 0811307.8

(51) Int. Cl. G01N 11/00; G01F 1/00; E21B 21/00

(52) U.S. Cl. 73/54.02; 73/861; 73/152.21

(57) ABSTRACT

The present invention relates to an apparatus (100) suitable for use in substantially continuous measurement of a physical property particularly the rheology and/or viscosity of a drilling fluid in use thereof in a drilling fluid or mud flow circuit of a drilling device. The present invention also relates to an apparatus (100) suitable for use in substantially continuous measurement of a physical property particularly the rheology and/or viscosity of any non-newtonian fluid is use thereof. The apparatus (100) comprises of a sample chamber (26) having an inlet (7) and an outlet (9) and is arranged to allow a drilling fluid to flow therethrough from the inlet 7 to the outlet (9). Detector devices (33, 34, 35) such as Viscometers are provided for substantially continuous measurement of a physical property particularly the rheology and/or viscosity of a drilling fluid flowing thought the sample chamber (26) in use of the apparatus (100). The sample chamber (26) has different diameters and has different flow rates and/or shear rates and will thus have different viscosities in a non-newtonian fluid which will be measured by a separate device such as a viscometer. Supply and return conduits are provided for connection of the inlet (7) and outlet (9) respectively in use of the apparatus (100) to a drilling fluid flow for delivering at least part of the drilling fluid flow through the apparatus (100) for measurement. A pump (18) produces a controlled flow of the diverted drilling fluid though the sample chamber (26) of the apparatus (100) so that the properties of the drilling fluid, particularly the rheology and/or viscosity can be measured on a more less continuous basis. A desirable backpressure in the sample chamber is controlled by a valve (8) on the outlet (9). The measurements of the separate devices (10) such as a viscometer can be used with other instruments to create a rheological model of the mud. The electrical signal generated by the viscometers (33, 34, 35) are sent for processing to a PC (12) and a device such as a chart and/or a data recorder (13). The direction of flow through the sample chamber (38) is shown by the arrows (39).

The present invention relates to a method and apparatus suitable for use in substantially continuous measurement of a physical property of a drilling fluid. More particularly, the present invention relates to substantially continuous measurement of the rheology and/or viscosity of a drilling fluid in use thereof.

More particularly, the present invention relates to substantially continuous measurement of the rheology and/or viscosity at different rates of shear of a drilling fluid in such a way that the changing viscosity of a non-newtonian fluid can be modelled in a useful way.

The so called modelling will be done by interpretation of data from identical viscometers which measure the viscosity of the mud which is moving at different speeds in different parts of the apparatus. These different speeds represent different shear rates in a similar way that rotational viscometers have different shear rates by adjustment of the speed of rotation.

To ensure the safe and efficient operation of down-hole drilling in drilling rigs or work-over rigs, a fluid generally referred to as a drilling fluid or simply mud or drilling mud is circulated into and out of the bore-hole being drilled or a bore-hole which has already been drilled. The drilling fluid is designed to match the chemical and physical environment of the particular well or type of well being drilled or which has already been drilled. Generally the drilling fluid is pumped into and out of the well by a so-called fluid pump or mud pump through the drill string and back up out through the annulus (formed between the drill string and the circumference of the well) of the well where the drilling fluid is deposited into a system of surface tanks, shale shakers, solids control equipment, filters etc, before being re-circulated if required for use down-hole. The fluid forms in use a column of fluid that creates a positive hydrostatic pressure within the well bore which allows wells to be drilled and/or repaired safely and efficiently.

As the fluid is circulated within the well bore, materials such as brine, silt and rock are removed from the well bore to the surface by the circulating fluid. The inclusion of such materials can have a detrimental effect on desired properties, such as viscosity and density, of the drilling fluid. To ensure the desired rheology and/or viscosity of the drilling fluid are maintained within operational parameters, measurements of the rheology and/or viscosity are made at regular intervals by on-site personnel. The rheology and/or viscosity may be checked using a Marsh Funnel or by a rotational viscometer such as a Fann 6 speed viscometer or other such devices. The measurement of the rheology and/or viscosity using a Marsh Funnel of a drilling fluid are generally made every half-hour or so and the results are generally considered to be representative of all the drilling fluid being circulated within the system at that particular time. The measurement of the rheology and/or viscosity using a rotational viscometer of a drilling fluid are generally made every 1 hour or 2 hour or . . . or so and the results are generally considered to be representative of all the drilling fluid being circulated within the system at that particular time.

However, the rheology and/or viscosity of the drilling fluid may vary considerably over a given period of time between each batch test of rheology and/or viscosity of the drilling fluid. Such variances are not desirable, particularly where the rheology and/or viscosity deviates from operationally acceptable parameters. Other more thorough and time consuming checks (often referred to as Mud tests or fluid checks) on the various desired properties of the drilling fluid are generally made to complement the regular batch testing of for example the rheology and/or viscosity of a drilling fluid. Again however, such testing is on a batch-by-batch basis and repeated only over time periods of at least every few hours or so. Such fluid test/checks require the attention of skilled personnel for relatively long periods of time, and although the results of the fluid tests checks are of particular importance to the continuing safe and efficient operation of the drilling operation, the results are generally only relevant to the particular batch of drilling fluid which has been checked, and cannot be viewed as being representative of the drilling fluid as a whole between such fluid tests/checks.

It will of course be appreciated that there are other types of non-newtonian fluids other than just drilling fluids or muds that could be rheologically monitored by this system. These could include emulsions and/or paints and/or industrial products and any other non-newtonian fluids.

It will of course be appreciated that there are a number of physical properties of a drilling fluid which are required to be checked more or less frequently, however the inventor has found that in order to ensure the safe and efficient operation of a drilling device using a said drilling fluid then it is highly desirable to more to less continuously monitor the rheology and/or viscosity of the drilling fluid as it is being used as these characteristics are particularly critical to the efficiency of the fluid.

In addition, the inventor has found that in order to ensure the safe and efficient operation of a drilling device using a said drilling fluid then it is highly desirable to more to less continuously monitor the rheology and/or viscosity of the drilling fluid in such a way that a rheological model of the non-newtonian mud can be continually and substantially instantly made.

It is an object of the present invention to avoid or minimise one or more of the disadvantages of known procedures.

According to the present invention there is provided a testing apparatus comprising:
a chamber having an inlet and an outlet such that fluid may flow therethrough from the inlet to the outlet;
measuring apparatus, at least a part of which is provided within said chamber;
the chamber being shaped or the apparatus otherwise adapted to cause the fluid flowing through the chamber in use, to vary from a first flow rate to at least a second different flow rate,
and the measuring apparatus is adapted to measure the fluid flow rate at each of the first and second flow rates.

Preferably in use, separate portions of the chamber experience the first and second flow rates.

Advantageously the shape of the chamber varies, and said variety in shape of the chamber causes the change in flow rate of the fluid. Most preferably the diameter of the chamber varies between portions.

Conveniently the chamber is shaped or the apparatus otherwise adapted to cause the fluid flow rate through the chamber in use, to vary from a first to at least a second, decreased, flow rate.

Preferably the diameter of the chamber at a first area corresponding to the area at which the fluid, in use, experiences the first flow rate, is 5-7 inches, preferably 5.5-6.5 inches, especially around 6 inches.

Preferably also the diameter of the chamber at a second area, corresponding to the area at which the fluid, in use, experiences the second flow rate, is 3-5 inches, preferably 3.5-4.5 inches, especially around 4 inches.

Preferably the chamber is shaped or the apparatus otherwise adapted to cause the fluid flow rate through the chamber in use, to vary from a first to a second flow rate and to a third different flow rate.

Preferably also the diameter of the chamber at a third area corresponding to the area at which the fluid, in use, experiences the third flow rate, is 1-3 inches, preferably 1.5-2.5 inches, especially around 2 inches.

Conveniently wherein the chamber is shaped or the apparatus otherwise adapted to cause the fluid flow rate through the chamber in use, to vary from a first to a second decreased flow rate and to a third, further decreased, flow rate.

Typically the measuring apparatus comprises at least two measuring devices, the measuring devices being provided in areas of the chamber which, in use, experience the different flow rates.

In another aspect the present invention provides an apparatus suitable for use in substantially continuous measurement of the rheology and/or viscosity at different shear rates of a drilling fluid during use thereof in a drilling fluid flow circuit of a drilling device, said apparatus comprising:
a sample chamber of varied diameter having an inlet and an outlet, the sample chamber being arranged to allow, in use of the apparatus, a drilling fluid to flow there through from said inlet to said outlet;
detector devices formed and arranged for substantially continuous measurement of the rheology and/or viscosity of a V drilling fluid flowing through the sample chambers at different shear rates in use of the apparatus
detector devices formed and arranged for substantially continuous measurement of the rheology and/or viscosity of a drilling fluid flowing through the sample chambers which have a varied diameter in use of the apparatus
supply and return conduits formed and arranged for connection of said inlet and outlet respectively, in use of the apparatus, to said drilling fluid flow circuit for delivering at least part of the drilling fluid flow through said apparatus;
a pump formed and arranged for providing a controlled flow of the diverted drilling fluid through the apparatus in use thereof.

Desirably the physical property of the drilling fluid to be measured is rheology and/or viscosity at two varied shear rates by two viscometers

Desirably the physical property of the drilling fluid to be measured is rheology and/or viscosity at three varied shear rates by three viscometers

Desirably the physical property of the drilling fluid to be measured is rheology and/or viscosity at four varied shear rates by four viscometers

By substantially continuous measurement of a said physical property, individual measurements of said physical property may be sequentially one after the other with little or no time interval between each said measurement i.e. in near real time. It will of course be appreciated that a time interval between individual measurements can exist and that such a time interval may be varied as required from one second to thirty minutes between individual measurements.

The flow circuit of drilling fluid is intended to refer to the piping, the drill string (where appropriate), the annulus between the drill string and the bore-hole and any other conduit and apparatus including reservoirs used to carry or direct drilling fluid in use thereof.

The sample chamber is desirably in the form of an elongate housing having said inlet at one end thereof and said outlet at the other end thereof. The housing may be of any shape and cross section preferably generally circular, square, rectangular, triangular or oval. Regular and irregular, polygonal shapes may also be considered.

Preferably the sample chambers are in the form of elongate cylinders having a longitudinal extent between the inlet and outlet thereof.

It will of course, be realised that the sample chamber may be constructed from a material which is capable of withstanding above atmosphere pressures and be more or less robust and resistant to corrosion. Preferred materials such as steel, particularly stainless steel (especially for use in hostile environment such as those found on sea based drilling rigs) are suitable for construction of the sample chamber.

Preferably, the sample chamber is arranged so that the inlets are raised vertically relative to the outlet thereof wherein an angle alpha is defined as the angle between the longitudinal extent and sample chamber which extents between the inlet and the outlet relative to the horizontal or vice-versa i.e. the outlet is raised above the inlet so that the sample chamber is disposed at the angle alpha relative to the horizontal preferably the angle alpha is from thirty to ninety degrees.

Where the sample chamber is arranged at an angle alpha relative to the horizontal this has the advantageous effect of minimising the settlement of various solid/semi solid components such as Baryte (barium sulphate which is used to inter alia increase the density of the drilling fluid) from the drilling fluid and the flow rate of the drilling fluid through the sample chamber is very low or has stopped altogether. Advantageously this prevents settlement around the detector device thereby minimising the risk of inaccurate measurements being taken.

The sample chamber may be arranged at an angle alpha relative to the horizontal allows any such solid/semi solids to move away under the influence of gravity from the inlet towards the outlet (or vice versa) of the sample chamber and thereby leaving the sample chamber relatively free of any said solids/semi solids which may precipitate or settle therefrom.

The detector devices are formed and arranged for continuous measurement of physical properties such as rheology and/or viscosity at different shear rates.

The detector devices may be any devices suitable for direct and/or indirect continuous measurements of the physical property of a said drilling fluid as it passes through the sample chamber. Where the detector is formed and arranged to measure said physical property directly, then preferably the detector is arranged to detect the rheology and/or viscosity of the drilling fluid.

More preferably, devices are also formed and arranged to measure the dynamic and kinematic viscosity, and even more preferably to also measure the temperature of the drilling fluid. Desirably, the detector device is in the form of a viscometer and/or a Densitometer.

More preferably, devices are also formed and arranged to measure the density of the mud to calculate the kinematic viscosity of the mud. Desirably, the detector device is in the form of a viscometer and/or a Densitometer such as the tuning fork devices model 7829 from Solartron/Mobrey.

Preferably the detector devices have a detector or measurement portion in the form of a tuning fork having a pair of parallel tines. The tines are inserted into the interior volume of the sample chamber and into a flow of the drilling fluid for direct measurement of a said physical property when in contact with the drilling fluid. Indirect measurements of said physical properties of the detector device may be achieved by forming and positioning the detector devices or at least a detector portion thereof adjacent or against the sample chamber wherein, in use, the detector device obtains inductive or capacitive measurements of the drilling fluid passing through the sample chamber and derives or quantifies a said physical property therefrom.

It will of course be appreciated that the detector device may utilise a combination of both direct and indirect measurements of one or more physical properties of the drilling fluid.

Desirably, the detector devices of the present invention are provided with a suitable display and/or recording apparatus so that the measurements of said physical properties can be monitored and/or recorded. Suitable display/recording apparatus include for example data loggers, personal computers, VDU's, printer devices etc. and any other similar device(s) which can be view preferably remotely e.g. in the pit room or shaker house of a drilling rig or from a remote location away from the drilling rig; or viewed when adjacent to the apparatus.

Desirably, the detector device of the present invention is provided with a suitable interface with other measuring devices on the drilling rig such as the pump pressure and/or the MWD (measurement while drilling) and/or any other appropriate device to create a substantially continuous rheological model which can be viewed preferably remotely e.g. in the pit room or shaker house of a drilling rig or from a remote location away from the drilling rig e.g. in a shore base operations room for offshore drilling; or viewed when adjacent to the apparatus.

Supply and return conduits for connection of the inlet and outlet to said drilling fluid flow circuit may be in the form of flexible or rigid pipes or hoses which can be connected to the drilling fluid flow circuit by positioning them at the desired point of suction and the desired point of discharge or connected to the drilling fluid flow circuit by suitable connector devices such as screw fittings. Desirably the supply conduit at least is connected to the drilling fluid flow circuit in use at a point thereon so as to deliver said at least part of the drilling fluid to the apparatus from said point wherein the drilling fluid is representative of the drilling fluid exiting a bore-hole or other area of operation where the drilling fluid is being used.

By connecting the supply conduit at least to a said point in a drilling fluid flow circuit a more accurate and precise i.e. a representative measurement of the physical properties of the drilling fluid being used within the drilling fluid flow circuit.

The pressure of the drilling fluid within the sample chamber in use is desirably within the range of from one to ten bars and preferably from three to five bars. The flow rate of drilling fluid in use flowing through the sample chamber is preferably from five to fifty litres/minute.

The pressure within the sample chamber may be varied by the provision of adjustable flow valves or other suitable throttling means disposed at/or downstream from the outlet of the sample chamber. In use the adjustable valves can be opened or closed incrementally so as to reduce or produce a backpressure within the sample chamber as a drilling fluid flows therethrough. By providing a backpressure within the sample chamber, entrained gas (or at least a proportion thereof) is reduced in volume or dissolved into solution with the fluid as a result of the increase in pressure acting thereof. Additionally, or alternatively gases may be prevented from being displaced from the solution by a said backpressure within the sample chamber. It is desirable to minimise the presence of entrained gases within the drilling fluid as it passes through the apparatus more particularly through the sample chamber, as the presence of bubbles of gas may lead to spurious measurements of the physical properties of the drilling fluid. Such spurious measurements are clearly undesirable as they may lead operating personnel to take unrequired correctional measurement to bring the measured physical property back within the operating parameters.

The pump for providing a control flow of said directed drilling fluid through the apparatus might be located upstream or downstream of the sample chamber. Preferably the pump is located upstream of the sample chamber i.e. before the inlet of the sample chamber.

The pump can be of any known type suitable for use in pumping drilling fluids, however, it will be appreciated that it is desirable to provide pumps which are intrinsically safe for use in environments such as oil drilling rigs i.e. pumps which have a negligible or reduced possibility of providing an ignition source for combustible materials e.g. hydrocarbons, gases, liquids which are generally found on oil drilling rigs. Particularly suitable pumps are pneumatically driven diaphragms pumps. Desirably, said pneumatically driven diaphragm pumps are driven by compressed air provided from a compressed air source such as for example a cylinder containing compressed air or a compressor unit.

Preferably the pump produces the flow rate of drilling fluid, which is substantially free of flow rate surges. Where a pump cannot produce a surge free flow of drilling fluid then the pump may be fitted with a device such as a pulsation damper or dampener to dampen any such flow surges.

As will be appreciated drilling fluids will contain large amounts of solid or semi solid material when the fluid returns to, for example, a drilling rig during a drilling operation. In order to reduce the possibility of damage to the apparatus in use thereof especially to the detector device and the pump the apparatus may be provided with one or more filters disposed upstream of the sample chamber wherein the filters are formed and arranged to remove unwanted and/or semi solid materials from a said diverted fluid flow passing through the apparatus. Preferably, the filters are directional in that they will allow only a fluid to pass in one direction therethrough. Desirably there is used a Y type strainer of generally known type and construction.

Desirably, the apparatus is formed and arranged in a compact and portable and robust form, which can be relatively easily transported to and from and on a rig site without the need of heavy lifting equipment. Preferably the apparatus is transportable in a small trailer capable of being towed behind a private or light goods vehicle. Desirably, the display on the apparatus can be mounted so that it can be placed inside the apparatus as a form of protection during transportation to and from the work site and is secured and attached to a cradle within the apparatus and is capable of being repositioned in a display position when transportation to and from the work site is complete.

Desirably, the apparatus is provided with an enclosure that is suitable for operations on a drilling rig in that it is so called explosion proof and has a so called ingress rating sufficiently high to prevent unwanted ingress of water or other fluid such as the water from a pressure washer the aforesaid enclosure to be used as a housing for electrical components such as voltage transformers, printed circuits, safety relays and other components required.

In a further aspect, the present invention also provides a method of substantially, continuously measuring a physical property of a drilling fluid during use thereof in a drilling fluid flow circuit of a drilling device, said method comprising the steps of;

a) providing an apparatus according to the first aspect of the present invention
b) providing a drilling fluid flow circuit
c) attaching the supply and return conduits of said apparatus to said drilling fluid flow circuit
d) pumping and drilling fluid from the drilling fluid flow circuit to provide a flow of drilling fluid through the sample chamber and
e) obtaining from the detectors the device substantially continuous of a said physical property of the drilling fluid as it passes through the sample chamber.

Desirably the apparatus is provided with an audio and/or visual alarm to notify operator personnel when a measured physical property falls out with a pre-defined operational parameter.

Preferably the apparatus of the present invention forms part of an active control system wherein the apparatus is formed and arranged with a control mechanism which adjusts the composition or other physical property of a drilling fluid when the apparatus detects that a physical property should be measured falls out with pre-defined operational parameters, so that the physical property is brought within said operational parameter.

The apparatus is preferably provided with an additional fluid feed in fluid communication with the sample chamber where in the inlet is formed and arranged to provide an additional volume of drilling fluid and/or a flushing fluid such as water to the sample chamber if required.

Any feature of any aspect of any invention or embodiment described herein may be combined with any feature of any aspect of any other invention or embodiment described herein mutatis mutandis.

Further preferred features and advantageous of the present invention will appear from the following detailed description given by way of some preferred embodiments illustrated with reference to the accompanying drawings in which;

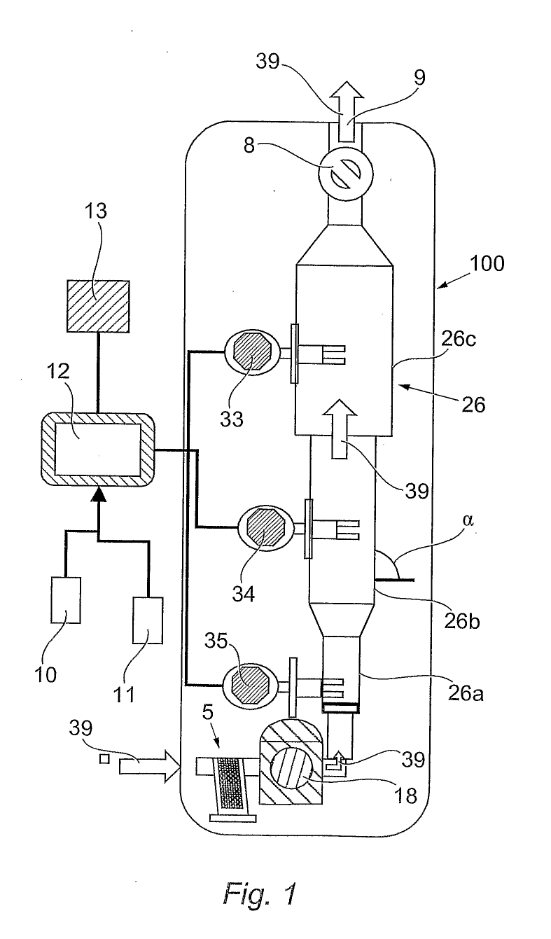

FIG. 1 is a schematic view of a test apparatus according to one embodiment of the present invention, and

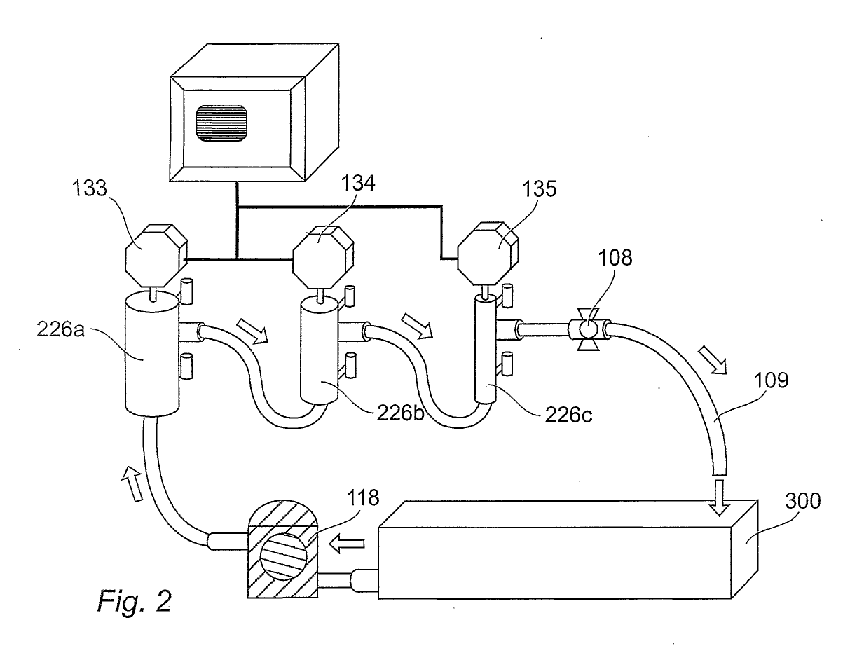

FIG. 2 is a schematic view of a test apparatus according to a second embodiment of the present invention.

Turning to the figures, FIG. 1 shows a diagrammatic view of a first embodiment of a test apparatus. The apparatus comprises a chamber 26 having an inlet 7 at one end and an outlet 9 at the other such that fluid flows through the chamber from the inlet to the outlet. The chamber is shaped to cause fluid flowing in the chamber to vary from a first flow rate to a second different flow rate, and from the second different flow rate to a third different flow rate. In this embodiment, the chamber is generally tubular and the diameter of the chamber increases between the inlet and the outlet of the chamber.

The chamber comprises a first chamber section 26a with a diameter of about 2 inches, a second chamber section 26b with a diameter of about 4 inches and a third chamber section 26c with a diameter of about 6 inches. The first and second chamber sections are illustrated as connected by a flared collar 26d and the second and third chamber sections are illustrated as connected at a flange or shoulder 26e although any suitable connection between the chambers may be provided.

Detector devices in the form of viscometers are provided to measure the rheology and/or viscosity of the fluids flowing through the chambers. A portion of the detector device is mounted within each of the chambers. In the preferred embodiment, the detector devices comprise a measurement portion in the form of a tuning fork with a pair of parallel tines. The tines are mounted within the first, second and third chamber portions.

The body of the detector devices is mounted on or adjacent to the outer surface of the chamber sections. Inductive or capacitive measurements of the drilling fluids passing through the sample chambers may be taken by the detector devices in order to derive physical properties of the fluids such as dynamic or kinematic viscosity or temperature of the fluids.

It will of course be appreciated that the detector device may utilise a combination of both direct and indirect measurements of one or more physical properties of the drilling fluid.

A pump 18 is provided upstream of the inlet of the chamber 26 and one or more filters, preferably directional filters 5 are provided upstream of the pump to strain and filter fluids entering the chamber. An adjustable valve 8 is provided at the outlet 9 of the chamber for controlling pressure in the sample chamber.

In use, drilling fluid such as mud is strained and filtered before being pumped into the sample chamber 26 in the direction 39. As the fluid passes from the first chamber section to the second and then the third, the change in diameter of the sections creates different flow rates for a constant and/or common pump output and thus the fluids passing through each chamber section experience different shear rates. The flow rate in use is preferably from five to fifty litres/minute.

The rheology and/or viscosity of the mud at the different shear rates is continuously measured by the viscometers 33, 34, 35 within each chamber.

The pressure in the sample chamber 26 is controlled by valve 8 and is preferably within the range of from three to five bars. The pressure may be varied by opening or closing the valve incrementally so as to reduce or produce a backpressure within the sample chamber as the drilling fluid flows therethrough. By providing a backpressure within the sample chamber, entrained gas (or at least a proportion thereof) is reduced in volume or dissolved into solution with the fluid as a result of the increase in pressure acting thereof. Additionally, or alternatively gases may be prevented from being displaced from the solution by a said backpressure within the sample chamber. It is desirable to minimise the presence of entrained gases within the drilling fluid as it passes through the apparatus more particularly through the sample chamber, as the presence of bubbles of gas may lead to spurious measurements of the physical properties of the drilling fluid. Such spurious measurements are clearly undesirable as they may lead operating personnel to take unrequired correctional measurement to bring the measured physical property back within the operating parameters.

The electrical signals from the viscometers 33, 34, 35 are sent to PC 12 and can be processed with additional signals from other devices 10, 11 measuring properties such as fluid flow rates, pump pressure, fluid temperature. The final signals are interpreted and displayed at a display/recording device such as computer 13. Other suitable display/recording apparatus include for example data loggers, personal computers, VDU's, printer devices etc. and any other similar devices which can be view preferably remotely e.g. in the pit room or shaker house of a drilling rig or from a remote location away from the drilling rig; or viewed when adjacent to the apparatus.

The sample chamber is inclined at an angle alpha which is preferably from 30 to 90 degrees relative to the horizontal and this allows any solid/semi solids to move away under the influence of gravity from the inlet towards the outlet (or vice versa) of the sample chamber and thereby leave the sample chamber relatively free of any said solids/semi solids which may precipitate or settle therefrom.

In FIG. 2 a second embodiment of the present invention is shown. In this embodiment the sample chambers are provided by three separate, generally cylindrical bodies connected together by pipework, hoses or suitable ducting. In this embodiment the first sample chamber has a greater diameter than the second sample chamber and the second sample chamber has a greater diameter than the third sample chamber. A detector in the form of a viscometer such as provided by Emerson Mobrey under the product number 7827 is connected to each chamber to measure rheology and/or viscosity of the mud travelling through each chamber.

In use, mud from a reservoir 300 is pumped by a diaphragm pump 118 upstream of the mud reservoir into the series of sample chambers 226a, 226b, 226c in the direction of the arrows. The varied size of the sample chambers 226a, 226b, 226c creates different flow rates for a constant and/or common pump output and thus different shear rates. The rheology and/or viscosity of the mud at the different shear rates is measured by the viscometers 133, 134, 135. The pressure in the sample chambers is controlled by valve 108 positioned before an outlet 109 of the test apparatus. The electrical signals from the viscometers 133, 134, 135 are sent to a gas signal converter such as a solarton 7951 gas meter from where they can be displayed or printed as required.

It will be appreciated that the present invention provides a testing apparatus and method which provides for substantially continuous measurement of a physical property of drilling fluids in real time which can assist operators to ensure safe and efficient operation of drilling facilities.

1. A testing apparatus comprising:
a chamber having an inlet and an outlet such that fluid may flow therethrough from the inlet to the outlet;
measuring apparatus, at least a part of which is provided within said chamber;
the chamber being shaped or the apparatus otherwise adapted to cause the fluid flowing through the chamber in use, to vary from a first flow rate to at least a second different flow rate, and the measuring apparatus is adapted to measure the fluid flow rate at each of the first and second flow rates.

2. Apparatus as claimed in claim 1, wherein in use, separate portions of the chamber experience the first and second flow rates.

3. Apparatus as claimed in claim 1, wherein the shape of the chamber varies, and said variety in shape of the chamber causes the change in flow rate of the fluid.

4. Apparatus as claimed in claim 3, wherein the diameter of the chamber varies.

5. Apparatus as claimed in claim 1, wherein the chamber is shaped or the apparatus otherwise adapted to cause the fluid flow rate through the chamber in use, to vary from a first to at least a second, decreased, flow rate.

6. Apparatus as claimed in claim 1, wherein the diameter of the chamber at a first area corresponding to the area at which the fluid, in use, experiences the first flow rate, is 5-7 inches, preferably 5.5-6.5 inches, especially around 6 inches.

7. Apparatus as claimed in claim 1, wherein the diameter of the chamber at a second area, corresponding to the area at which the fluid, in use, experiences the second flow rate, is 3-5 inches, preferably 3.5-4.5 inches, especially around 4 inches.

8. Apparatus as claimed in claim 1, wherein the chamber is shaped or the apparatus otherwise adapted to cause the fluid flow rate through the chamber in use, to vary from a first to a second flow rate and to a third different flow rate.

9. Apparatus as claimed in claim 1, wherein the diameter of the chamber at a third area corresponding to the area at which the fluid, in use, experiences the third flow rate, is 1-3 inches, preferably 1.5-2.5 inches, especially around 2 inches.

10. Apparatus as claimed in claim 8, wherein the chamber is shaped or the apparatus otherwise adapted to cause the fluid flow rate through the chamber in use, to vary from a first to a second decreased flow rate and to a third, further decreased, flow rate.

11. An apparatus substantially for use in substantially continuous measurements of a physical property of a drilling fluid during use thereof in a drilling fluid flow circuit of a drilling device, said apparatus comprising:
a sample chamber having an inlet and an outlet, the sample chamber being arranged to allow in use of the apparatus drilling fluid flow therethrough from said inlet to said outlet;
detector devices formed and substantially arranged for substantially continuous measurement of a physical property of a drilling fluid flowing through the sample chamber in use of the apparatus;
supply and return conduits formed and arranged for connection of said outlet and inlet respectively in use of the apparatus to said drilling fluid flow circuit for delivering at least part of the drilling fluid flow through said apparatus; and
a pump formed and arranged for providing as controlled flow of the diverted drilling fluid through the apparatus in use thereof.

12. Apparatus as claimed in claim 11, wherein the sample chamber is in the form of an elongated housing having said outlet at one end thereof and said outlet the other end thereof.

13. Apparatus as claimed in claim 11, wherein said sample chamber is in the form of an elongate cylinder having a longitudinal extent between the inlet and outlet thereof.

14. Apparatus as claimed in claim 11, wherein said sample chamber is arranged so that the outlet is raised vertical relative to the inlet thereof wherein an angle alpha is defined as the angle between the longitudinal extent of the sample chamber which extends between the inlet and the outlet, relative to the horizontal and vice versa wherein in use, the sample chamber being arranged at an said angle alpha relative to the vertical, solids/semi-solids contained within a said drilling fluid move away under the influence of gravity from the outlet towards the inlet or vice versa of the sample chamber and the thereby leaving the detector device relatively clear of any said solids/semi-solids.

15. Apparatus as claimed in claim 14, wherein the angle alpha is from 30 to 90 degrees.

16. Apparatus as claimed in claim 11, wherein the detector devices are devices formed and arranged for direct and/or substantially continuous measurement of a physical property of a drilling fluid as it passes, in use, thought the sample chamber.

17. Apparatus as claimed in claim 11, wherein the detector devices are at least one of a Densitometer and a viscometer.

18. Apparatus as claimed in claim 11, wherein, there is provided a means of throttling the flow of the drilling fluid thought the sample chamber formed and arranged so as to produce back pressure within the sample chamber, wherein the back-pressure reduces the volume of at least a proportion of the entrained gases within the drilling fluid as it passes through the sample chamber.

19. Apparatus as claimed in claim 18, wherein the backpressure in the sample chamber is in the range of from 1 to 10 bar (1 to 10×10⁵ N/m²).

20. Apparatus as claimed in claim 11, wherein the flow rate, in use, of a drilling fluid flowing through the sample chamber is from 5 to 50 litres per minute.

21. Apparatus as claimed in claim 11, wherein the pump is located upstream before the inlet of the sample chamber.

22. Apparatus as claimed in claim 11, wherein the pump is a pneumatically driven diaphragm pump.

23. Apparatus as claimed in claim 11, wherein the apparatus is provided with a device formed and arranged to dampen any flow-rate surges produced by the operation of the pump.

24. Apparatus as claimed in claim 11, wherein the apparatus is provided with one or more filters disposed upstream of the sample chamber wherein the filters are formed and arranged to remove unwanted materials from a diverted fluid flow passing, in use, through the apparatus.

25. Apparatus as claimed in claim 11, wherein the sample chamber is formed with different cross sectional areas to create areas of different shear rates.

26. Apparatus as claimed in claim 11, wherein the sample chamber is formed with portions of different cross sectional areas to create areas of different flow rate and thus different shear rates on which different viscometers measure and/record the rheology and/or viscosity.

27. Apparatus as claimed in claim 11, wherein the detector devices also measure the density of the fluid which can be substantially used to calculate the so called kinematic viscosity.

28. Apparatus as claimed in claim 11, wherein the detector devices are connected to other measuring devices such as the pump pressure and/or an MWD recorder and/or any other suitable device.

29. Apparatus as claimed in claim 11, wherein the detector devices are connected to other measuring devices such as the pump pressure and/or an MWD recorder and/or any other suitable devices and calculate a meaningful interpretation of the so called rheological properties of the mud on surface and/or downhole and/or any part of the drill string annulus.

30. Apparatus as claimed in claim 11, wherein the fluid is a non-newtonian fluids.

31. (canceled)

32. A method of substantially continuous measuring a physical property of a drilling fluid during use thereof in a drilling fluid flow circuit of a drilling device, said method comprising the steps of:
a) providing an apparatus according to claim 11;
b) providing a drilling fluid flow circuit;
c) attaching the supply and return conduits of said apparatus to said drilling fluid circuit;
d) pumping fluid from the drilling fluid flow circuit to provide a flow of drilling fluid through the sample chamber; and
e) obtaining from the detector devices substantially continuous measurements of a said physical property of the drilling fluid as it passes though the sample chamber.

33. (canceled)

34. An active control system comprising an apparatus as claimed in claim 11 formed and arranged with a control means, which in use adjusts the composition or other physical properties of a drilling fluid when the apparatus detects that a physical property to be measured falls out-with pre-defined operational parameters, so that the physical property is brought within said operational parameters.

35. (canceled)
